(19) United States
(12) Patent Application Publication
(10) Pub. No.: US 2012/0164952 A1
(43) Pub. Date: Jun. 28, 2012

(54) METHOD AND APPARATUS FOR OPTIMIZATION TO MINIMIZE RADIO LINK FAILURE

(75) Inventors: Chan Yong LEE, Daejeon (KR); Eun Seon CHO, Daejeon (KR); Hong Soog KIM, Daejeon (KR); Hyeon Ju OH, Daejeon (KR); Hwan Souk YOO, Daejeon (KR); Nam Hoon PARK, Daejeon (KR)

(73) Assignee: Electronics and Telecommunications Research Institute, Daejeon (KR)

(21) Appl. No.: 13/332,333

(22) Filed: Dec. 20, 2011

(30) Foreign Application Priority Data
Dec. 22, 2010 (KR) 10-2010-0132625

(51) Int. Cl. H04W 24/00

(52) U.S. Cl. 455/67.11

(57) ABSTRACT

An optimization system that minimizes a radio link failure may be provided. In the optimization system, a base station may include a measured data collecting unit to collect wireless environment data measured by a terminal included in a cell, a threshold managing unit to manage a threshold value associated with a radio link failure in a wireless section, an analyzing unit to manage a variable associated with a radio link failure, and to analyze a cause of the radio link failure, and a parameter changing unit to change a parameter value based on an analysis result of the analyzing unit.

### CROSS-REFERENCE TO RELATED APPLICATION

This application claims the benefit of Korean Patent Application No. 10-2010-0132625, filed on Dec. 22, 2010, in the Korean Intellectual Property Office, the disclosure of which is incorporated herein by reference.

### BACKGROUND

1. Field of the Invention

The present invention relates to a method and apparatus for optimizing a wireless environment, and more particularly, to a method and apparatus for minimizing a radio link failure between a terminal and a base station.

2. Description of the Related Art

In a mobile communication system, particularly, the long term evolution (LTE) or the LTE-advanced system of the 3^{rd} generation partnership project (3GPP), a base station requests a terminal to measure data, and collects the measured data. The terminal may report, to the base station, wireless environment measurement information associated with a current cell and a neighboring cell. In this example, the measured data reported by the terminal to the base station may include the wireless environment measurement information associated with the current cell and the neighboring cell, but may not include information to be used for improving a cell environment.

Therefore, there is a drawback in that an operator is required to monitor circumstances of a cell, periodically, for each season, or for each time interval, to improve wireless environment information of the cell, for the cell environment.

### SUMMARY

An aspect of the present invention provides an apparatus and method for sensing a wireless environment automatically based on measured data associated with a wireless environment, and improving a current cell environment, so as to provide a service smoothly in an installed base station or an existing base station.

According to an aspect of the present invention, there is provided a base station in an optimization system that minimizes a radio link failure, the base station including a measured data collecting unit to collect wireless environment data measured by a terminal included in a cell, a threshold managing unit to manage a threshold value associated with a radio link failure in a wireless section, an analyzing unit to manage a variable associated with a radio link failure, and to analyze a cause of the radio link failure, and a parameter changing unit to change a parameter value based on an analysis result of the analyzing unit.

The base station may further include an optimizing unit to determine whether an optimization is supported when a radio link failure occurs, and to transfer, to an optimization server, an optimization request signal due to the radio link failure when the optimization is not supported.

The base station may further include a parameter reporting unit to transmit the changed parameter value to the terminal or an optimization server.

The analyzing unit may classify the radio link failure based on a type of a cause of the radio link failure so as to manage the radio link failure.

The base station may further include a connection resetting unit to reset a wireless connection with the terminal when a radio link failure occurs.

The parameter changing unit may change the parameter value when a number of radio link failures is greater than a threshold value set by the threshold managing unit.

According to another aspect of the present invention, there is provided an optimization server in an optimization system that minimizes a radio link failure, the optimization server including a measured data collecting unit to receive, from a base station, wireless environment data collected by a terminal, a threshold managing unit to manage a threshold value associated with a radio link failure between the base station and the terminal, an analyzing unit to manage a variable associated with a radio link failure, and to analyze a cause of the radio link failure, and a parameter changing unit to change a parameter value based on an analysis result.

When the radio link failure occurs and an optimization is not supported by the base station, the optimization server may change the parameter value for the optimization.

The optimization server may further include a parameter reporting unit to transmit the changed parameter value to the terminal and the base station when the parameter value is changed for the optimization, due to the radio link failure occurring between the terminal and the base station.

The analyzing unit may classify the radio link failure based on a type of a cause of the radio link failure.

According to still another aspect of the present invention, there is provided a method of operating a base station in an optimization system that minimizes a radio link failure, the method including collecting wireless environment data from a terminal, determining whether an optimization is supported when the radio link failure occurs, analyzing a type of a cause of the radio link failure when the optimization is supported, and changing a parameter value based on an analysis result.

The analyzing may be performed when a number of radio link failures is greater than the threshold value.

The method may further include transmitting, to the terminal or the optimization server, the parameter value changed based on the analysis result.

According to yet another aspect of the present invention, there is provided a method of operating an optimization server in an optimization system that minimizes a radio link failure, the method including receiving, from a base station, wireless environment data collected by a terminal when an optimization is not supported by the base station, analyzing a type of a cause of the radio link failure between the base station and the terminal, and changing a parameter value based on an analysis result.

The analyzing may be performed when a number of radio link failures is greater than a threshold value.

The method may further include transmitting, to the base station, the parameter value changed based on the analysis result.

According to further another aspect of the present invention, there is provided an optimization system that minimizes a radio link failure, the system including a terminal to collect wireless environment data including current location information in response to a request for collecting measured data from a base station, to transmit the collected data to the base station, to receive, from the base station or an optimization server, a changed parameter value when a radio link failure occurs, the base station to receive data from the terminal, and to change a parameter value when the radio link failure occurs, and the optimization server to receive, from the base station, the wireless environment data collected by the terminal, and to change a parameter value when the radio link failure occurs, and to transmit the changed parameter value to the base station.

Additional aspects, features, and/or advantages of the invention will be set forth in part in the description which follows and, in part, will be apparent from the description, or may be learned by practice of the invention.

### EFFECT

Exemplary embodiments may minimize a handover failure or interference adaptively, or may maintain coverage appropriately, so as to improve a service provided to users.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a configuration of a mobile communication system including a femto base station according to an embodiment of the present invention;

FIG. 2 is a diagram illustrating connections among apparatuses according to an embodiment of the present invention;

FIG. 3 is a block diagram illustrating a terminal according to an embodiment of the present invention;

FIG. 4 is a block diagram illustrating a base station according to an embodiment of the present invention;

FIG. 5 is a block diagram illustrating an optimization server according to an embodiment of the present invention;

FIG. 6 is a flowchart illustrating an operation of a base station in an optimization system that minimizes a radio link failure according to an embodiment of the present invention;

FIG. 7 is a flowchart illustrating an operation of changing a parameter value in an optimizing operation of the base station of FIG. 6 that minimizes a radio link failure; and

FIG. 8 is a flowchart illustrating an operation of an optimization server in an optimization system that minimizes a radio link failure according to an embodiment of the present invention.

### DETAILED DESCRIPTION

Reference will now be made in detail to embodiments of the present invention, examples of which are illustrated in the accompanying drawings, wherein like reference numerals refer to the like elements throughout. Embodiments are described below to explain the present invention by referring to the figures.

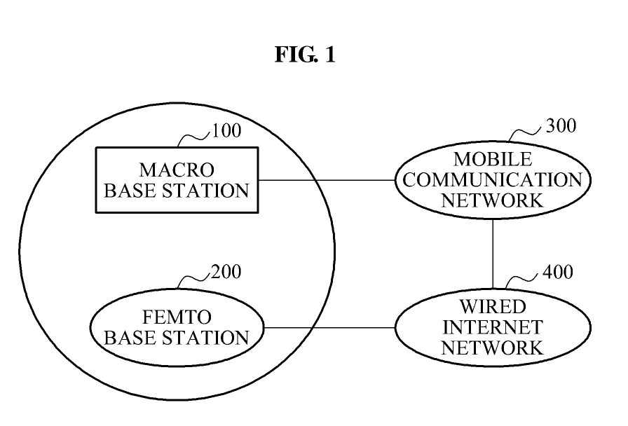

FIG. 1 illustrates a configuration of a mobile communication system including a femto base station 200 according to an embodiment of the present invention.

Referring to FIG. 1, the femto base station 200 forming a femtocell may be installed or disposed around a macro base station 100 forming a macrocell. The femto base station 200 may operate by being connected with a mobile communication network 300 through a wired Internet network 400. The macro base station 100 forming the macrocell may operate by being connected with the mobile communication network 300.

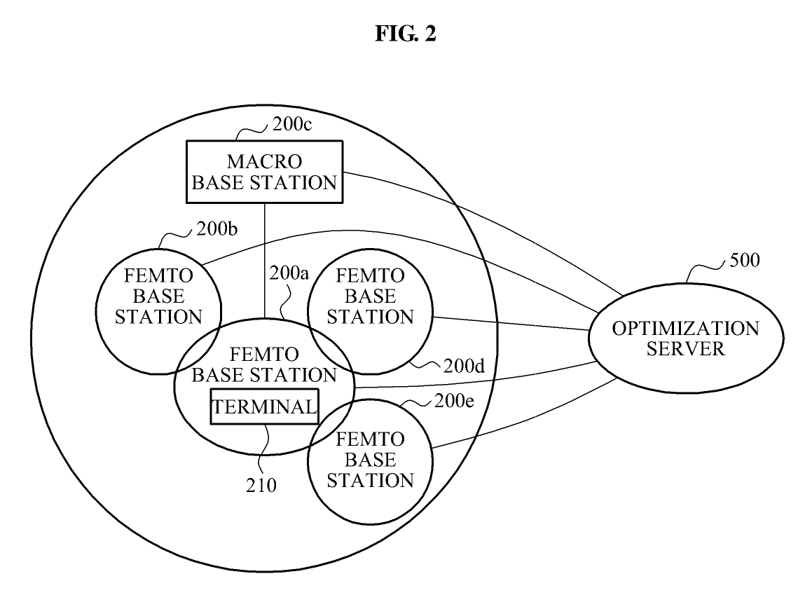

FIG. 2 illustrates connections among apparatuses according to an embodiment of the present invention.

Referring to FIG. 2, a base station for minimizing a radio link failure may collect, from a terminal 210, measured data associated with a wireless environment of a corresponding cell and a neighboring cell. A femto base station 200a may collect, from the terminal 210, wireless environment data of femto base stations 200a, 200b, 200c, 200d, and 200e. The femto base station 200a may improve a wireless environment parameter value based on the collected wireless environment data and thus, radio resources may be utilized effectively. Also, the femto base station 200a may report the wireless environment data to an optimization server 500, depending on a situation, and the optimization server 500 may improve a wireless environment parameter value and thus, wireless resources may be utilized efficiently.

The terminal 210 may transmit, to the femto base station 200a, wireless environment data including wireless environment information of the terminal 210 and current location information of the terminal 210, in response to a request for collecting measured data from the femto base station 200a. Transmission of the wireless environment data may be performed either periodically or when an event occurs.

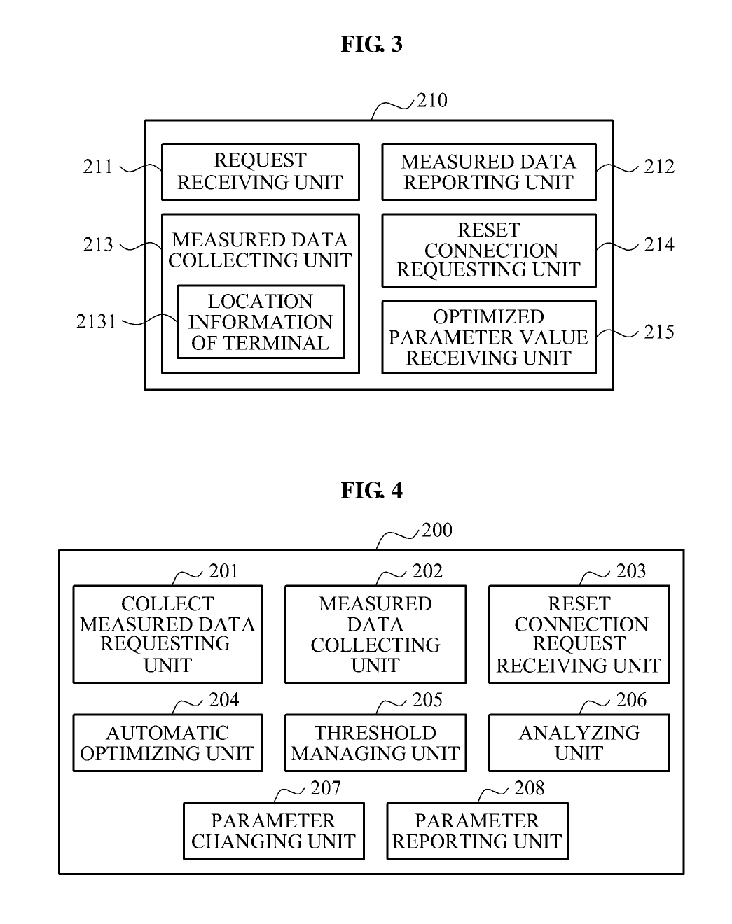

FIG. 3 illustrates the terminal 210 according to an embodiment of the present invention.

Referring to FIG. 3, the terminal 210 may include a request receiving unit 211, a measured data reporting unit 212, a measured data collecting unit 213, a reset connection requesting unit 214, an optimized parameter value receiving unit 215.

The request receiving unit 211 may receive, from a base station, a signal that requests measured wireless environment data.

The measured data collecting unit 213 may collect wireless environment data including location information 2131 of the terminal 210. Here, wireless environment data may refer to data associated with a wireless environment of a corresponding cell and a neighboring cell of a base station connected with a terminal. The measured data reporting unit 212 may transmit, to the base station, wireless environment data collected by the measured data collecting unit 213. The measured data reporting unit 212 may transmit, to the base station, the collected wireless environment data, periodically or when an event occurs.

When the terminal 210 fails to connect a radio link with the base station, the reset connection requesting unit 214 may transmit, to the base station, a signal requesting reconnecting of a radio link with the base station.

The optimized parameter value receiving unit 215 may receive a parameter value for optimizing a wireless environment, from the base station or an optimization server. The parameter value may be changed by the base station or the optimization server, when the radio link failure occurs.

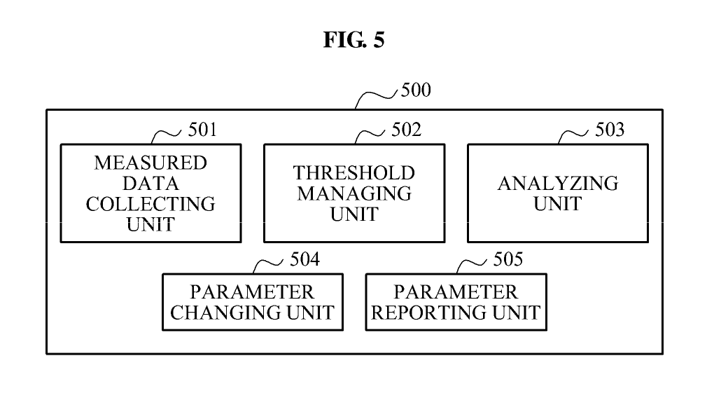

FIG. 4 illustrates the femto base station 200 according to an embodiment of the present invention.

Referring to FIG. 4, the femto base station 200 may include a collect measured data requesting unit 201, a measured data collecting unit 202, a reset connection request receiving unit 203, an automatic optimizing unit 204, a threshold managing unit 205, an analyzing unit 206, a parameter changing unit 207, and a parameter reporting unit 208.

The collect measured data requesting unit 201 may request wireless environment data to be measured by a terminal, so as to collect the wireless environment data from the terminal.

The measured data collecting unit 202 may collect and manage the wireless environment data requested by the measured data collecting request unit 201.

The reset connection request receiving unit 203 may receive, from the terminal, a signal requesting resetting of a radio link when a failure of a radio link with the terminal occurs.

The automatic optimizing unit 204 may determine whether an optimization mode for optimizing a wireless environment is performed when the radio link failure occurs, and may transmit, to an optimization server, a signal requesting performing of the optimization mode when the optimization mode is not supported.

The threshold managing unit 205 may store and manage a threshold value for a number of radio link failures, to be used for determining whether to change a wireless environment parameter when the failure of the radio link with the terminal occurs.

The analyzing unit 206 may manage and analyze geographical and environmental variables associated with the failure of the radio link with the terminal, for each type.

The parameter changing unit 207 may change a parameter value to correspond to a variable associated with the radio link failure analyzed by the analyzing unit 206.

The parameter reporting unit 208 may determine whether to report the changed parameter value to the terminal or an optimization server, and may transmit the changed parameter to the terminal or the optimization server.

FIG. 5 illustrates the optimization server 500 according to an embodiment of the present invention.

Referring to FIG. 5, the optimization server 500 may include a measured data collecting unit 501, a threshold managing unit 502, an analyzing unit 503, a parameter changing unit 504, and a parameter reporting unit 505.

The measured data collecting unit 501 may collect, from a base station, wireless environment data measured by a terminal.

The threshold managing unit 502 may store and manage a threshold value to be used for changing a wireless environment parameter in the optimization server 500 when a radio link failure occurs between the base station and the terminal.

The analyzing unit 503 may manage and analyze, for each type, varied geographic and environmental variables associated with the radio link failure between the base station and the terminal.

The parameter changing unit 504 may change a parameter value to correspond to a variable associated with the radio link failure, analyzed by the analyzing unit 206.

The parameter reporting unit 505 may determine whether to report the changed parameter value to the base station, and may transmit the changed parameter value to the base station.

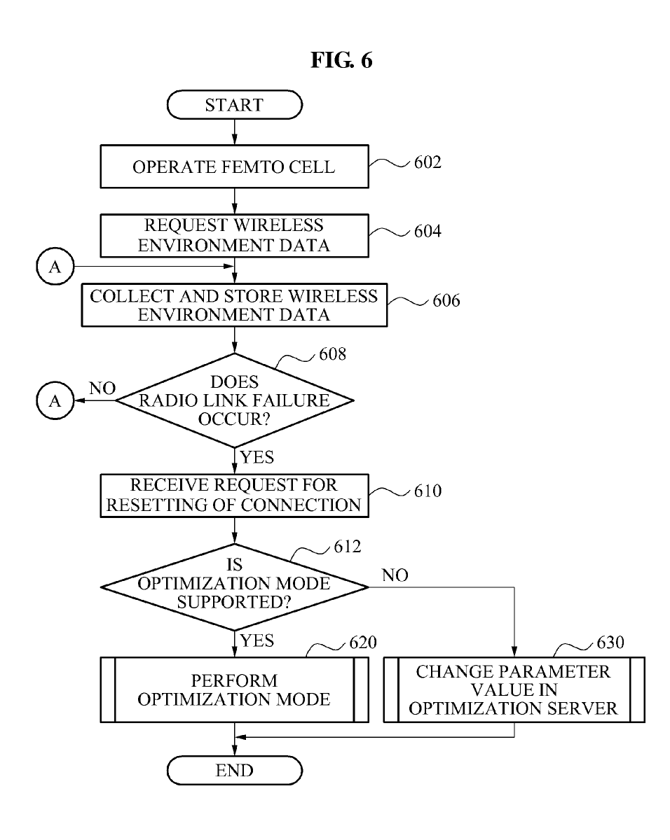

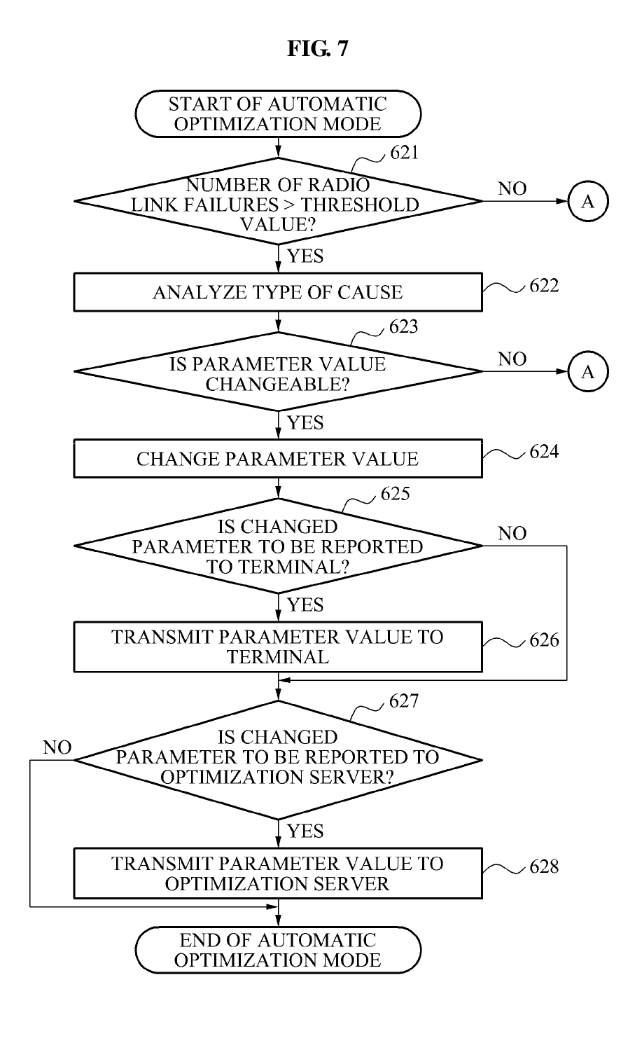

FIG. 6 illustrates an operation of a base station in an optimization system that minimizes a radio link failure according to an embodiment of the present invention.

Referring to FIG. 6, the base station may require wireless environment data previously collected by a terminal in operation 604. The base station may collect and store the wireless environment data, periodically or when an event occurs in operation 606.

The base station may determine whether a radio link failure occurs, based on the collected wireless environment data in operation 608. When the radio link failure occurs, the base station may receive a signal requesting resetting of a connection with the terminal in operation 610.

The base station may determine whether an optimization mode is supported in operation 612, and, when the optimization mode is supported, an optimization mode may be performed due to the radio link failure in operation 620.

Conversely, when the optimization mode is not supported, an optimization server may perform an optimization mode requesting a change of a parameter value to optimize a wireless environment in operation 630.

Operations of performing the optimization mode in the base station will be described with reference to FIG. 7.

FIG. 7 illustrates an operation of changing a parameter value in an optimizing operation of the base station of FIG. 6 that minimizes a radio link failure.

Referring to FIG. 7, the base station may determine whether a number of radio link failures is greater than a predetermined threshold value in operation 621. When the number of radio link failures is greater than the predetermined threshold value, the base station may analyze a type of a radio link failure received from a terminal in operation 622.

The base station may determine, based on an analysis result, whether the parameter value is changeable for improving the wireless environment in operation 623. Here, varied parameter values may exist for each event associated with the radio link failure. For example, the parameter value may be a reference signal received power (RSRP) or a reference signal received quality.

The base station may change a parameter value associated with the radio link failure in operation 624, and may determine whether to report the changed parameter value to the terminal in operation 625.

The base station may transmit the changed parameter value to the terminal in operation 626 when the base station determines the changed parameter is to be reported to the terminal. The base station may determine whether to transmit the changed parameter value to an optimization server. When the base station determines to transmit the changed parameter value to the optimization server, the base station may transmit the changed parameter value in operation 628.

Conversely, when an optimization mode is not supported as a result of the determination in operation 612, the base station may perform an optimization mode in the optimization server.

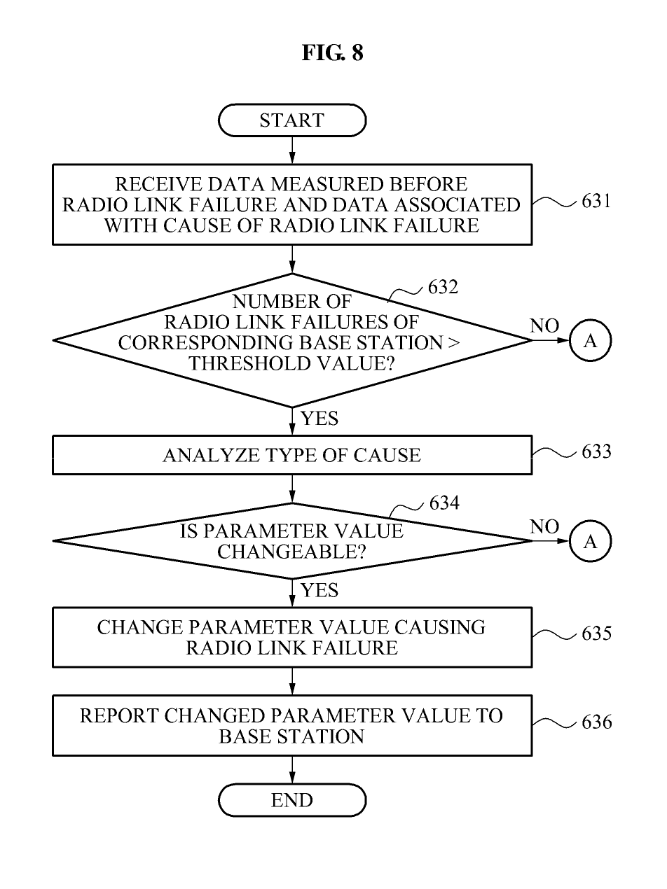

Operations of performing the optimization mode in the optimization server will be described with reference to FIG. 8.

FIG. 8 illustrates an operation of an optimization server in an optimization system that minimizes a radio link failure according to an embodiment of the present invention.

Referring to FIG. 8, the optimization server may receive, from a base station, a cause of a radio link failure, wireless environment data, and location information of a terminal before the radio link failure in operation 631.

The optimization server may determine, based on the received data, whether a number of radio link failures between the base station and the terminal is greater than a predetermined threshold value in operation 632.

When the optimization server determines that the number of radio link failures is greater than the threshold value, and the base station fails to connect a radio link, the optimization server may analyze a type of a cause of the radio link failure. The optimization server may determine whether to change a wireless environment parameter value based on an analysis result associated with the radio link failure in operation 634. The optimization server may change a parameter value associated with the radio link failure, to improve the wireless environment in operation 635, and may transmit the changed parameter value to the bases station in operation 636.

The method according to the above-described embodiments of the present invention may be recorded in non-transitory computer readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A base station in an optimization system that minimizes a radio link failure, the base station comprising:
a measured data collecting unit to collect wireless environment data measured by a terminal included in a cell;
a threshold managing unit to manage a threshold value associated with a radio link failure in a wireless section;
an analyzing unit to manage a variable associated with a radio link failure, and to analyze a cause of the radio link failure; and
a parameter changing unit to change a parameter value based on an analysis result of the analyzing unit.

2. The base station of claim 1, further comprising:
an optimizing unit to determine whether an optimization is supported when a radio link failure occurs, and to transfer, to an optimization server, an optimization request signal due to the radio link failure when the optimization is not supported.

3. The base station of claim 1, further comprising:
a parameter reporting unit to transmit the changed parameter value to the terminal or an optimization server.

4. The base station of claim 1, wherein the analyzing unit classifies the radio link failure based on a type of a cause of the radio link failure so as to manage the radio link failure.

5. The base station of claim 1, further comprising:
a connection resetting unit to reset a wireless connection with the terminal when a radio link failure occurs.

6. The base station of claim 1, wherein the parameter changing unit changes the parameter value when a number of radio link failures is greater than a threshold value set by the threshold managing unit.

7. An optimization server in an optimization system that minimizes a radio link failure, the optimization server comprising:
a measured data collecting unit to receive, from a base station, wireless environment data collected by a terminal;
a threshold managing unit to manage a threshold value associated with a radio link failure between the base station and the terminal;
an analyzing unit to manage a variable associated with a radio link failure, and to analyze a cause of the radio link failure; and
a parameter changing unit to change a parameter value based on an analysis result.

8. The optimization server of claim 7, wherein, when the radio link failure occurs and an optimization is not supported by the base station, the optimization server changes the parameter value for the optimization.

9. The optimization server of claim 7, further comprising:
a parameter reporting unit to transmit the changed parameter value to the terminal and the base station when the parameter value is changed for the optimization, due to the radio link failure occurring between the terminal and the base station.

10. The optimization server of claim 7, wherein the analyzing unit classifies the radio link failure based on a type of a cause of the radio link failure.

11. A method of operating a base station in an optimization system that minimizes a radio link failure, the method comprising:
collecting wireless environment data from a terminal;
determining whether an optimization is supported when the radio link failure occurs;
analyzing a type of a cause of the radio link failure when the optimization is supported; and
changing a parameter value based on an analysis result.

12. The method of claim 11, wherein the analyzing is performed when a number of radio link failures is greater than the threshold value.

13. The method of claim 11, further comprising:
transmitting, to the terminal or the optimization server, the parameter value changed based on the analysis result.

14. A method of operating an optimization server in an optimization system that minimizes a radio link failure, the method comprising:
receiving, from a base station, wireless environment data collected by a terminal when an optimization is not supported by the base station;
analyzing a type of a cause of the radio link failure between the base station and the terminal; and
changing a parameter value based on an analysis result.

15. The method of claim 14, wherein the analyzing is performed when a number of radio link failures is greater than a threshold value.

16. The method of claim 14, further comprises:
transmitting, to the base station, the parameter value changed based on the analysis result.

17. An optimization system that minimizes a radio link failure, the system comprising:
a terminal to collect wireless environment data including current location information in response to a request for collecting measured data from a base station, to transmit the collected data to the base station, to receive, from the base station or an optimization server, a changed parameter value when a radio link failure occurs;
the base station to receive data from the terminal, and to change a parameter value when the radio link failure occurs; and
the optimization server to receive, from the base station, the wireless environment data collected by the terminal, and to change a parameter value when the radio link failure occurs, and to transmit the changed parameter value to the base station.
